(19) United States
(12) Patent Application Publication
(10) Pub. No.: US 2026/0186835 A1
(43) Pub. Date: Jul. 2, 2026

(54) SYSTEMS, METHODS, AND MEDIA FOR CONTROLLING BANDWIDTH ALLOCATED TO PROCESSING HOSTS REQUESTS AND RELOCATING DATA

(71) Applicant: SK hynix NAND Product Solutions Corp., Rancho Cordova, CA (US)

(72) Inventors: Paul Ruby, Folsom, CA (US); David J. Pelster, Longmont, CO (US); Mark Anthony Golez, Folsom, CA (US); Teena Sebastian, Newark, CA (US); Holman Su, Sacramento, CA (US)

(21) Appl. No.: 19/006,981

(22) Filed: Dec. 31, 2024

(51) Int. Cl. G06F 9/50

(52) U.S. Cl. CPC G06F 9/5016; G06F 9/5033; G06F 9/5055

(57) ABSTRACT

Mechanisms for controlling a solid-state drive (SSD), including: determining a workload type of the SSD using a hardware processor; determining an available bandwidth of the SSD based on at least the workload type; determining a number of host requests allowed to be processed during a current time interval based at least on the available bandwidth and a target moving average of flash translation layer (FTL) relocation source bands of the SSD; determining a number of relocations allowed to be performed in the SSD during the current time interval based at least on a number of host requests that were allowed to have been processed in a previous time interval, the target moving average, and an actual moving average of FTL relocation source bands of the SSD; and controlling the SSD to process the number of host requests and perform the number of relocations during the current time interval.

### BACKGROUND

Solid-state drives (SSDs) are widely used in computing devices for storing data and/or programs. Normal processes in SSDs include processing requests (e.g., to write data) from host systems and relocating data as part of garbage collection processes.

Current mechanisms for controlling bandwidth allocated to processing hosts requests and relocating data are inadequate.

Accordingly, new mechanisms for controlling bandwidth allocated to processing hosts requests and relocating data are desirable.

### SUMMARY

In accordance with some embodiments, new mechanisms, including systems, methods, and media, for controlling bandwidth allocated to processing hosts requests and relocating data are provided.

In some embodiments, systems for controlling a number of host requests to be processed and a number of relocations to be performed in a solid-state drive (SSD) are provided, the systems comprising: memory; and at least one hardware processor coupled to the memory and collectively configured to at least: determine a workload type of the SSD; determine an available bandwidth of the SSD based on at least the workload type; determine a number of host requests allowed to be processed during a current time interval based at least on the available bandwidth and a target moving average of flash translation layer (FTL) relocation source bands of the SSD; determine a number of relocations allowed to be performed in the SSD during the current time interval based at least on a number of host requests that were allowed to have been processed in a previous time interval, the target moving average, and an actual moving average of FTL relocation source bands of the SSD; and control the SSD to process the number of host requests and perform the number of relocations during the current time interval. In some of these embodiments, the available bandwidth is also based on a queue depth of the SSD and the target moving average. In some of these embodiments, the available bandwidth is also based on a number of active bandwidth share requests from one or more media policies. In some of these embodiments, the number of host requests allowed to be processed is also based on a number of active data integrity bandwidth share requests. In some of these embodiments, the number of host requests allowed to be processed is also based on how long a previous interval took divided by how long the previous interval was anticipated to take. In some of these embodiments, the number of host requests allowed to be processed is determined based on an amount of free space on the SSD. In some of these embodiments, the number of relocations allowed to be performed is determined based on an amount of free space on the SSD. In some of these embodiments, the number of host requests allowed to be processed is based on a number of relocation operations performed during the previous time interval.

In some of these embodiments, methods for controlling a number of host requests to be processed and a number of relocations to be performed in an SSD are provided, the methods comprising: determining a workload type of the SSD using a hardware processor; determining an available bandwidth of the SSD based on at least the workload type; determining a number of host requests allowed to be processed during a current time interval based at least on the available bandwidth and a target moving average of flash translation layer (FTL) relocation source bands of the SSD; determining a number of relocations allowed to be performed in the SSD during the current time interval based at least on a number of host requests that were allowed to have been processed in a previous time interval, the target moving average, and an actual moving average of FTL relocation source bands of the SSD; and controlling the SSD to process the number of host requests and perform the number of relocations during the current time interval. In some of these embodiments, the available bandwidth is also based on a queue depth of the SSD and the target moving average. In some of these embodiments, the available bandwidth is also based on a number of active bandwidth share requests from one or more media policies. In some of these embodiments, the number of host requests allowed to be processed is also based on a number of active data integrity bandwidth share requests. In some of these embodiments, the number of host requests allowed to be processed is also based on how long a previous interval took divided by how long the previous interval was anticipated to take. In some of these embodiments, the number of host requests allowed to be processed is determined based on an amount of free space on the SSD. In some of these embodiments, the number of relocations allowed to be performed is determined based on an amount of free space on the SSD. In some of these embodiments, the number of host requests allowed to be processed is based on a number of relocation operations performed during the previous time interval.

In some of these embodiments, non-transitory computer-readable media containing computer executable instructions that, when executed by a processor, cause the processor to perform a method for controlling a number of host requests to be processed and a number of relocations to be performed in an SSD are provided, the method comprising: determining a workload type of the SSD; determining an available bandwidth of the SSD based on at least the workload type; determining a number of host requests allowed to be processed during a current time interval based at least on the available bandwidth and a target moving average of flash translation layer (FTL) relocation source bands of the SSD; determining a number of relocations allowed to be performed in the SSD during the current time interval based at least on a number of host requests that were allowed to have been processed in a previous time interval, the target moving average, and an actual moving average of FTL relocation source bands of the SSD; and controlling the SSD to process the number of host requests and perform the number of relocations during the current time interval. In some of these embodiments, the available bandwidth is also based on a queue depth of the SSD and the target moving average. In some of these embodiments, the available bandwidth is also based on a number of active bandwidth share requests from one or more media policies. In some of these embodiments, the number of host requests allowed to be processed is also based on a number of active data integrity bandwidth share requests. In some of these embodiments, the number of host requests allowed to be processed is also based on how long a previous interval took divided by how long the previous interval was anticipated to take. In some of these embodiments, the number of host requests allowed to be processed is determined based on an amount of free space on the SSD. In some of these embodiments, the number of relocations allowed to be performed is determined based on an amount of free space on the SSD. In some of these embodiments, the number of host requests allowed to be processed is based on a number of relocation operations performed during the previous time interval.

### BRIEF DESCRIPTION OF THE DRAWINGS

FIG. 1 is a block diagram of an example SSD in accordance with some embodiments.

FIG. 2 is a flow diagram of an example process for controlling bandwidth allocated to processing host requests and relocating data in accordance with some embodiments.

FIGS. 3A and 3B are flow diagrams of example processes that can be used for training a machine learning classifier to determine workload types in accordance with some embodiments.

FIG. 4 is a flow diagram of an example process for using a machine learning classifier to determine workload types in accordance with some embodiments.

### DETAILED DESCRIPTION

In accordance with some embodiments, new mechanisms, including systems, methods, and media, for controlling bandwidth allocated to processing hosts requests and relocating data are provided.

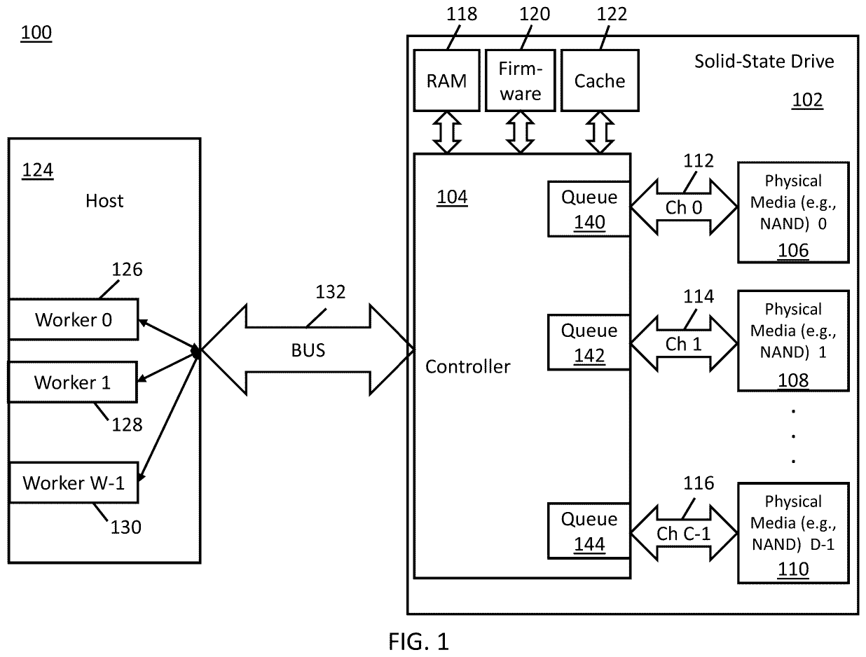

Turning to FIG. 1, an example block diagram of a solid-state drive 102 coupled to a host device 124 via a bus 132 in accordance with some embodiments is illustrated.

As shown, solid-state drive 102 can include a controller 104, physical media (e.g., NAND devices) 106, 108, and 110, channels 112, 114, and 116, random access memory (RAM) 118, firmware 120, and cache 122 in some embodiments. In some embodiments, more or fewer components than shown in FIG. 1 can be included. In some embodiments, two or more components shown in FIG. 1 can be included in one component.

Controller 104 can be any suitable controller for a solid-state drive in some embodiments. In some embodiments, controller 104 can include any suitable hardware processor(s) (such as a microprocessor, a digital signal processor, a microcontroller, a programmable gate array, etc.). In some embodiments, controller 104 can also include any suitable memory (such as RAM, firmware, cache, buffers, latches, etc.), interface controller(s), interface logic, drivers, etc. In some embodiments, controller 104 can be coupled to, or include (as shown), channel queues 140, 142, and 144 for transmitting commands (which can include command data) over channels 140, 142, and 144 to physical media 106, 108, and 110, respectively.

Physical media 106, 108, and 110 can be any suitable physical media for storing information (which can include data, programs, and/or any other suitable information that can be stored in a solid-state drive) in some embodiments. For example, the physical media can be NAND devices in some embodiments.

The physical media can include any suitable memory cells, hardware processor(s) (such as a microprocessor, a digital signal processor, a microcontroller, a programmable gate array, etc.), interface controller(s), interface logic, drivers, etc. in some embodiments. While three physical media (106, 108, and 110) are shown in FIG. 1, any suitable number D of physical media (including only one) can be used in some embodiments. Any suitable type of physical media (such as single-level cell (SLC) NAND devices, multilevel cell (MLC) NAND devices, triple-level cell (TLC) NAND devices, quad-level cell (QLC) NAND devices, penta-level cell (PLC) NAND, NAND with suitable levels of cells, 2D NAND devices, 3D NAND devices, NOR flash memory, any other suitable flash technology, phase change memory technology, and/or other any other suitable volatile and/or non-volatile memory storage technology) can be used in some embodiments. Each physical media can have any suitable size in some embodiments. While physical media 106, 108, and 110 can be implemented using NAND devices, the devices can additionally or alternatively use any other suitable storage technology or technologies, such as NOR flash memory or any other suitable flash technology, phase change memory technology, and/or other any other suitable non-volatile memory storage technology.

Channels 112, 114, and 116 can be any suitable mechanism for communicating information between controller 104 and physical media 106, 108, and 110 in some embodiments. For example, the channels can be implemented using conductors (lands) on a circuit board in some embodiments. While three channels (112, 114, and 116) are shown in FIG. 1, any suitable number C of channels can be used in some embodiments.

Random access memory (RAM) 118 can include any suitable type of RAM, such as dynamic RAM, static RAM, etc., in some embodiments. Any suitable number of RAM 118 can be included, and each RAM 118 can have any suitable size, in some embodiments.

Firmware 120 can include any suitable combination of software and hardware in some embodiments. For example, firmware 120 can include software programmed in any suitable programmable read only memory (PROM) in some embodiments. Any suitable number of firmware 120, each having any suitable size, can be used in some embodiments.

Cache 122 can be any suitable device for temporarily storing information (which can include data and programs in some embodiments), in some embodiments. Cache 122 can be implemented using any suitable type of device, such as RAM (e.g., static RAM, dynamic RAM, etc.) in some embodiments. Any suitable number of cache 122, each having any suitable size, can be used in some embodiments.

Host device 124 can be any suitable device that accesses stored information in some embodiments. For example, in some embodiment, host device 124 can be a general-purpose computer, a special-purpose computer, a desktop computer, a laptop computer, a tablet computer, a server, a database, a router, a gateway, a switch, a mobile phone, a communication device, an entertainment system (e.g., an automobile entertainment system, a television, a set-top box, a music player, etc.), a navigation system, etc. While only one host device 124 is shown in FIG. 1, any suitable number of host devices can be included in some embodiments.

In some embodiments, host device 124 can include workers 126, 128, and 130. While three workers (126, 128, and 130) are shown in FIG. 1, any suitable number of workers W can be included in some embodiments. In some embodiments, at least two workers can be included. A worker can be any suitable hardware and/or software that reads and/or writes data from and/or to solid-state drive 102.

Bus 132 can be any suitable bus for communicating information (which can include data and/or programs in some embodiments), in some embodiments. For example, in some embodiments, bus 132 can be a PCIE bus, a SATA bus, or any other suitable bus.

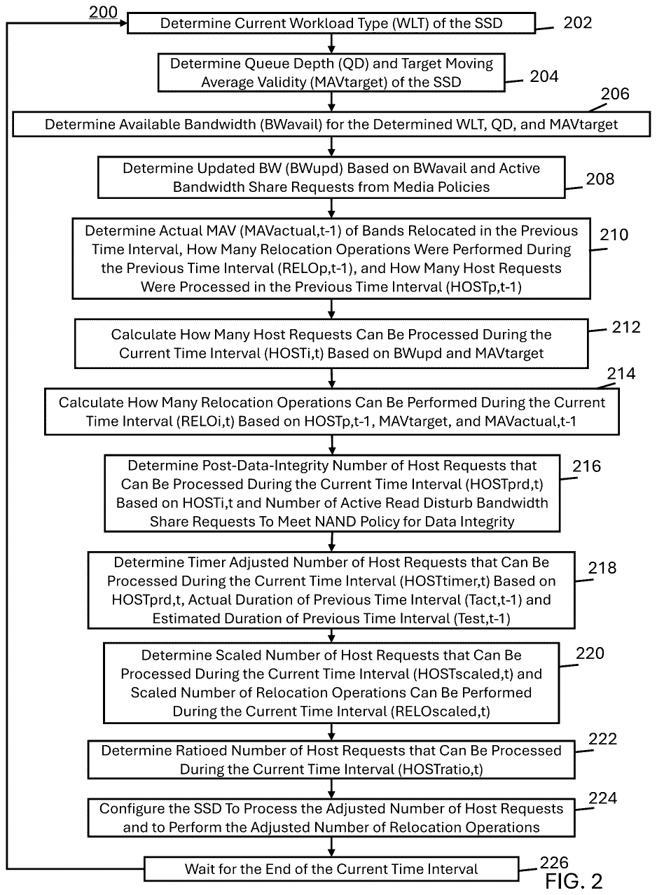

Turning to FIG. 2, a flow diagram of an example process 200 for controlling the processing of host requests and relocation operations of an SSD in accordance with some embodiments is illustrated. Process 200 can be executed by controller 104 of FIG. 1, in some embodiments.

As shown in FIG. 2, process 200 executes in a loop with last block 226 being to wait for the end of the current time interval before looping back to the beginning of the process (block 202) to repeat performing the process for the next time interval. As such, the description below refers to the current time interval and the previous time interval. These intervals can have any suitable duration, and the duration of each interval can vary based on any suitable characteristic(s) of the SSD, such as current workload type.

As shown, after process 200 begins, at 202, the process determines a current workload type (WLT) of the SSD. This determination can be made in any suitable manner in some embodiments. For example, this determination can be performed as described below following the description of FIG. 2. As another example, this determination can be made by using heuristics-based algorithms to determine workload characteristics, such as by determining the moving average validity (MAV) value (i.e., the moving average of the validity of flash translation layer (FTL) relocation source bands) of bands processed for garbage collection, and using this value to identify a workload type typically having this or a similar value. As yet another example, this determination can be made by determining a read/write I/O mix (e.g., 75% read, 25% write), workload queue depth (e.g., queue depth 1 or 128), and I/O size (e.g., 4 Kbytes or 128 Kbytes), and using these values to identify a workload type typically having these or similar values.

Next, at 204, process 200 determines a queue depth (QD) of the SSD and a target moving average validity (MAVtarget) of the SSD. These determinations can be made in any suitable manner. For example, in some embodiments, queue depth can be determined by tracking the number of queued events (Writes/Reads) and MAVtarget can be determined as a percentage of valid data on all bands queued for relocation.

Then, at 206, process 200 determines an available bandwidth (BWavail) for the determined WLT, QD, and MAVtarget of the SSD. This determination can be made in any suitable manner, in some embodiments. For example, in some embodiments, this determination can be made by accessing a look-up table that receives WLT, QD, and MAVtarget as inputs and provides as an output BWavail for the SSD. The data for such a look-up table can be generated empirically, in some embodiments. In some embodiments, the available bandwidth determination can be based on any suitable one or more characteristics of the SSD.

Process 200 next determines, at 208, an updated bandwidth (BWupd) based on BWavail and a sum of the bandwidth requested in active bandwidth share requests from media policies of the SSD. The determination can be made in any suitable manner, in some embodiments. For example, this determination can be made by subtracting the sum of the bandwidth requested in the active bandwidth share requests from media policies of the SSD from BWavail. This determination can be based on any suitable active bandwidth share requests from any suitable media policies, in some embodiments.

At 210, process 200 next determines actual MAV values of bands relocated in the previous time interval (MAVactual,t−1), how many relocation operations were performed during the previous time interval (RELOp,t−1), and how many host write requests were processed in the previous time interval (HOSTp,t−1). These determinations can be made in any suitable manner, in some embodiments. For example, in some embodiments, these determinations can be made by receiving feedback from processes that control garbage collection on bands, that control relocation operations, and that track host metrics on the SSD.

Next, at 212, process 200 calculates how many host requests can be processed during the current time interval (HOSTi,t). This determination can be made in any suitable manner, in some embodiments. For example, in some embodiments, process 200 can calculate how many host requests can be processed during the current time interval using the following formula:

$$HOSTi , t = int ( BWupd * ( 1 - MAVtarget ) * α ) ,$$

where:
HOSTi,t is the number of host requests allowed to be processed during the current time interval;
BWupd is the updated bandwidth determined at 208;
MAVtarget is the target moving average validity determined at 204;
α is a scaling value that relates the bandwidth to the effort required to process a host request, and can be omitted from this equation in some embodiments.

As another example, in some embodiments, process 200 can calculate how many host requests can be processed during the current time interval using the following formula:

$$HOSTi , t = int ( BWupd * MAItarget * α ) ,$$

where:
MAItarget is the target moving average invalidity, which is equal to (1−MAVtarget), where MAVtarget is determined at 204.

Then, at 214, process 200 calculates how many relocation operations can be performed during the current time interval (RELOi,t). This determination can be made in any suitable manner, in some embodiments. For example, in some embodiments, process 200 can calculate how many relocation operations can be performed during the current time interval using the following formula:

$$RELOi , t = int ( HOSTp , t - 1 * ( 1 / ( 1 - MAVtarget ) ) * ( 1 + ( MAVtarget - MAVactual , t - 1 ) ) * β ) ,$$

where:
RELOi,t is the number of relocation operations allowed to be performed during the current time interval;
HOSTp,t−1 is the number of host write requests that were processed in the previous time interval as determined at 210;
MAVtarget is the target moving average validity determined at 204;
MAVactual,t−1 is the actual moving average validity determined at 210; and
β is a scaling value that relates the bandwidth to the effort required to process a relocation operation, and can be omitted from this equation in some embodiments.

At 216, process 200 next determines a post-data-integrity number of host requests that can be processed during the current time interval (HOSTprd,t) to meet NAND policy for data integrity. This determination can be made in any suitable manner, in some embodiments. For example, in some embodiments, this determination can be made by subtracting from HOSTi,t an amount of host requests corresponding to a received number of active data integrity bandwidth share requests. This determination can be based on any suitable active data integrity bandwidth share requests, in some embodiments.

Then, at 218, process 200 determines a timer-adjusted number of host requests that can be processed during the current time interval (HOSTtimer,t) based on HOSTprd,t, the actual duration of the previous time interval (Tact,t−1), and the estimated duration of the previous time interval (Test,t−1). For example, this determination can be made based on the following equation:

$$HOSTtimer , t = int ( HOSTprd , t * Tact , t - 1 / Test , t - 1 ) .$$

Next, at 220, process 200 determines the scaled number of host requests that can be processed during the current time interval (HOSTscaled,t) and the scaled number of relocation operations that can be performed during the current time interval (RELOscaled,t) based on the free space available on the SSD (free_space) with respect to one or more thresholds. Any suitable number of thresholds can be used in some embodiments, and these adjustments can be performed in any suitable manner, in some embodiments. For example, in some embodiments, N thresholds can be used (where N is an integer number greater than or equal to two), the N thresholds can be ordered from lowest to highest values and can be identified as Thr_i (where i has a value of 1 to N), such that Thr_1 has the lowest value and Thr_N has the highest value. In this example, the adjustments can be calculated as follows:
if the free space is greater than Thr_N:

$$HOSTscaled , t = int ( HOSTtimer , t + RELOi , t * α / β ) ; and$$

$$RELOscaled , t = 0 ;$$

where:
   α converts bandwidth units to number of host requests that can be processed; and
   β converts bandwidth units to number of relocation operations that can be performed.
if the free space is less than or equal to Thr_N and greater than or equal to Thr_1:

$$HOSTscaled , t = int ( HOSTtimer , t + W ( r ) * α ) ;$$

$$RELOscaled , t = int ( RELOi , t - W ( r ) * β ) ;$$

where:
   r identifies a range of free space values between two adjacent ones of the N thresholds in which the current free space lies;
   W(r) is a number of bandwidth units to be transferred between host requests and relocation operations for a given range r and can have any suitable positive or negative value that can be determined in any suitable manner (e.g., empirically);
   α converts bandwidth units to number of host requests that can be processed; and
   β converts bandwidth units to number of relocation operations that can be performed.
if the free space is less than Thr_1:

$$HOSTscaled , t = 0$$

$$RELOscaled , t = int ( HOSTtimer , t * β / α + RELOi , t )$$

where:
   α converts bandwidth units to number of host requests that can be processed; and
   β converts bandwidth units to number of relocation operations that can be performed.

Then, at 222, process 200 determines a ratioed number of host requests that can be processed during the current time interval (HOSTratio,t) based on HOSTscaled,t, the number of relocation operations performed during the previous time interval (RELOp,t−1) determined at 210, and the scaled number of relocations operations that could have been performed during the previous time interval (RELOscaled,t−1). This determination can be made in any suitable manner, in some embodiments. For example, in some embodiments, this determination can be made based on the following equation:

$$HOSTratio , t = int ( HOSTscaled , t * RELOp , t - 1 / RELOscaled , t - 1 * α / β ) .$$

Next, at 224, process 200 configures the SSD to process the ratioed number of host requests, HOSTratio,t, and to perform the scaled number of relocation operations, RELOscaled,t, during the current time interval. The configuring can be performed in any suitable manner, in some embodiments. For example, in some embodiments, a number of credits for each of the ratioed number of host requests to be processed during the current time interval and the scaled number of relocation operations to be performed during the current time interval can be assigned and these numbers of credits can be provided to processes that control the number of host requests that are processed and the number of relocation operations that are performed.

Finally, process 200 waits for the end of the current time interval at 226 and then loop back to 202. This waiting can be performed in any suitable manner in some embodiments. For example, in some embodiments, process 200 can wait for amount of time corresponding to the estimated interval to pass since the process last began at 202 before looping back to 202. As another example, in some embodiments, process 200 can wait for a signal that indicates that the current time interval has ended before looping back to 202. As yet another example, in some embodiments, process can end at 202 and wait to be re-triggered before proceeding to 202.

Examples of mechanisms, including systems, methods and media for determining workload types that can be used in accordance with some embodiments are described below. These mechanisms can be used to determine the workload type at 202 of process 200 of FIG. 2, in some embodiments.

In some embodiments, a workload type is determined using a machine learning classifier (hereinafter referred to as a “classifier”). Any suitable type of classifier that is based on machine learning can be used in some embodiments. For example, in some embodiments, a classifier can be implemented using a neural network. As a more particular example, in some embodiments, a classifier can be implemented using a deep neural network. In some embodiments, when the classifier is implemented as a neural network, any suitable activation functions, such as leaky ReLU and sigmoid activation functions, can be used in the neural network. In some embodiments, when the classifier is implemented as a neural network, the neural network can have any suitable number and size of hidden layers, use any suitable learning rate (e.g., 0.001), use any suitable loss function (e.g., a mean square error (MSE) loss function), be trained using an adaptive moment estimation (“Adam”) optimizer, and/or use a loss based technique such that when a loss threshold is reached (e.g., <10%) training is stopped to prevent an overfit.

In some embodiments, a classifier used to determine workload types can make this determination based upon any suitable inputs. For example, in some embodiments, a classifier used to determine a workload type of a workload can make this determination based upon a moving average validity (MAV) of bands in an SSD processed for garbage collection while processing the workload, a read/write input/out mix of the workload, a queue depth of the workload, input/output sizes of the workload, a read type (e.g., system or host) of the workload, a number of outstanding commands of the workload, start logical block address (LBA), input/output source (e.g., host, system, garbage collection, media policy, etc.), and/or any other suitable inputs.

In some embodiments, a classifier used to determine workload types can produce any suitable outputs. For example, in some embodiments, a classifier used to determine workload types can produce outputs including an indicator that indicates whether the workload is in a steady state, a type of workload that is currently being presented, for each of a plurality of workload types, a likelihood that the current workload is of that workload type, and/or any other suitable outputs.

In order for a machine learning classifier to determining a workload type, the machine learning classifier can be trained to do so and/or be configured to do so based on another machine learning classifier that was trained to do so.

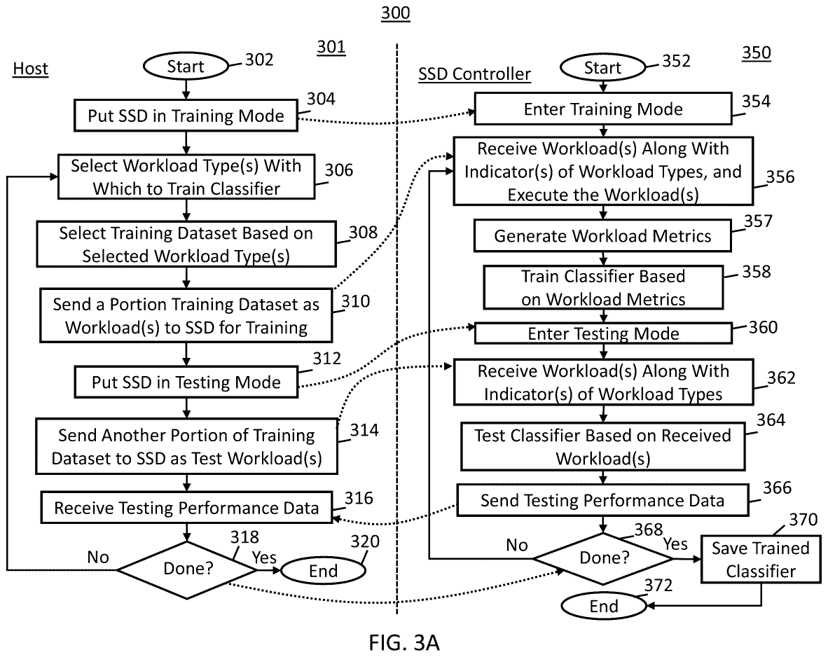

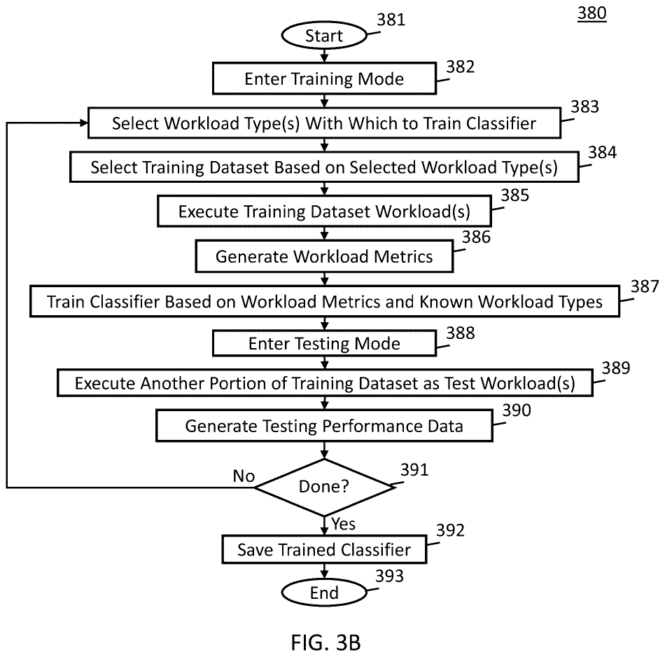

Turning to FIG. 3A, an example 300 of a process for training a machine learning classifier that can be used to determine a workload type of an SSD in accordance with some embodiments is illustrated. As shown, process 300 includes a portion 301 that is executed by a host and a portion 350 that is executed by an SSD controller, in some embodiments.

As shown, after process 301 begins at 302, the process puts the SSD in a training mode 304. Putting the SSD in a training mode can be accomplished in any suitable manner in some embodiments. For example, in some embodiments, process 301 can send a command to the SSD at 304 to put the SSD in a training mode.

After process 350 begins at 352, and in response to process 301 putting the SSD into a training mode, process 350 can enter the training mode at 354. Process can enter the training mode in any suitable manner. For example, in entering the training mode, process 350 can cause a classifier of the SSD to be configured to be trained. As another example, in some embodiments, a classifier can be initialized. More particularly, for example, when implemented with a neural network, the classifier can be initialized with normal Xavier initialization and zero biases.

Next, at 306, process 301 can select one or more workload types upon which the classifier in the SSD is to be trained. Any suitable workload types and suitable number of them can be selected at 306, and the workload types can be selected based on any suitable criteria or criterion. For example, in some embodiments, process 301 can select certain workload types that are applicable to a particular type of the SSD, a particular application for the SSD, a particular industry for which the SSD is intended, one or more particular customers, etc.

Then, at 308, process 301 can select a training dataset based on the selected workload type(s). Any suitable training dataset can be selected in any suitable manner, and the training dataset can have any suitable size. For example, in some embodiments, the training dataset can be selected to have workload examples that correspond to the select workload types.

In some embodiments, the training dataset can have any suitable content. For example, in some embodiments, the training dataset can include workload commands and data as well as indicators that indicate, for each portion of the training dataset, the workload type that corresponds to that portion.

Next, at 310, process 301 can send a portion of the training dataset as one or more workloads to the SSD for training. This portion can be sent in any suitable manner. For example, this portion can be sent in the same manner as a corresponding non-training workload would be sent to the SSD, in some embodiments. More particularly, the portion can be sent to the SSD from the host as a series of commands along with corresponding data (if applicable). In some embodiments, the indicators of the workload type can be sent together with the commands and corresponding data (if applicable), while in other embodiments, the indicators of the workload type can be sent separate from the commands and corresponding data (if applicable).

At 356, process 350 can receive the workload(s) along with the indicator(s) of the workload types, and execute the workload(s).

Process 350 can generate workload metrics at 357. Any suitable workload metrics can be generated in any suitable manner. For example, in some embodiment, generated workload metrics can include a moving average validity (MAV) of bands in an SSD processed for garbage collection while processing the workload, a read/write input/out mix of the workload, a queue depth of the workload, input/output sizes of the workload, a read type (e.g., system or host) of the workload, a number of outstanding commands of the workload, start logical block address (LBA), input/output source (e.g., host, system, garbage collection, media policy, etc.), and/or any other suitable metrics.

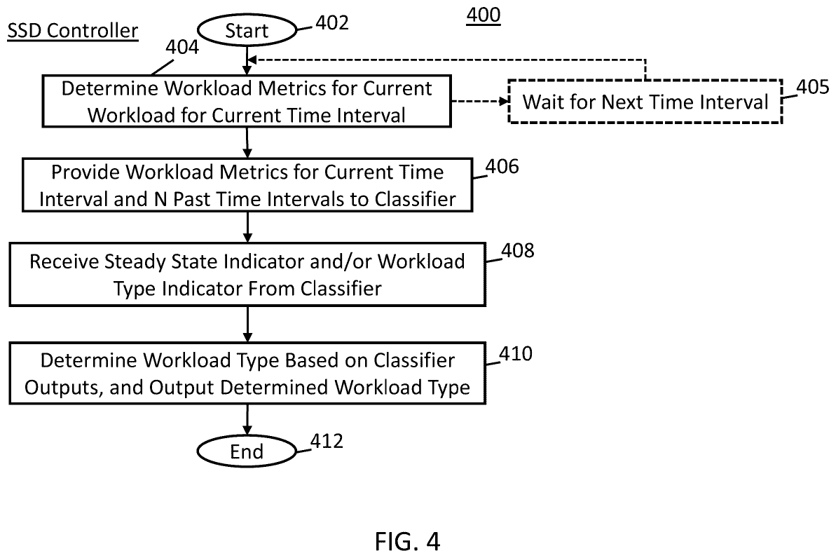

Next, at 358, process 350 can train the classifier using the received workload(s). The classifier can be trained using the received workload(s) in any suitable manner, in some embodiments. For example, in some embodiments, process 350 can provide the classifier with workload metrics from a given number of intervals (as described below in connection with 406 of FIG. 4), receive an output from the classifier, and modify the classifier through backpropagation based on the output and the workload type(s) indicated by the training dataset. In some embodiments, the classifier can be trained using an adaptive moment estimation (“Adam”) optimizer.

After training is complete, at 312, process 301 can put the SSD into a testing mode. Putting the SSD in a testing mode can be accomplished in any suitable manner in some embodiments. For example, in some embodiments, process 301 can send a command to the SSD at 312 to put the SSD in a testing mode.

In response to process 301 putting the SSD into a testing mode, process 350 can enter the testing mode at 360. Process 350 can enter the testing mode in any suitable manner, in some embodiments. For example, in entering the testing mode, process 350 can cause a classifier of the SSD to be configured to evaluate workloads presented to determine their workload types as well as monitor the accuracy of those determinations based on indicators of workload type(s) provided with the workloads.

Next, at 314, process 301 can send another portion of the training dataset to the SSD as test workload(s). This other portion can be sent to the SSD in any suitable manner, in some embodiments. For example, this portion can be sent in the same manner as a corresponding non-training workload would be sent to the SSD, in some embodiments. More particularly, the portion can be sent to the SSD from the host as a series of commands along with corresponding data (if applicable). In some embodiments, the indicators of the workload type can be sent together with the commands and corresponding data (if applicable), while in other embodiments, the indicators of the workload type can be sent separate from the commands and corresponding data (if applicable).

At 362, process 350 can receive the workload(s) along with the indicator(s) of the workload types, and execute the workload(s).

Then, at 364, process 350 can test the trained classifier based on the received workloads. Process 350 can test the trained classifier based on the received workloads in any suitable manner, in some embodiments. For example, in testing the trained classifier, process 350 can evaluate workloads presented to determine their workload types (e.g., as described below in connection with 404, 405, 406, 408, and 412 of FIG. 4) as well as monitor the accuracy of those determinations based on indicators of workload type(s) provided with the workloads, in some embodiments.

Next, at 366, process 350 can send testing performance data to process 301. This performance data can be sent in any suitable manner, in some embodiments. Any suitable performance data can be sent, in some embodiments. For example, in some embodiments, the performance data can include accuracy data.

Process 301 can receive testing performance data at 316.

At 318, process 301 can then determine, based on the performance data and/or any other suitable metric or combination of metrics, whether the classifier has been sufficiently trained. Any suitable performance data can be used to determine whether the classifier has been sufficiently trained, in some embodiments. For example, in some embodiments, process 301 can determine that the classifier has been sufficiently trained when the accuracy of the classifier is within one standard deviation or other statistic distance (e.g., 10%) of the known workload types indicated in the training data.

If process 301 determines at 318 that the classifier has not been sufficiently trained, the process can loop back to 306.

Otherwise, the process can end at 320.

At 368, process 350 can then determine, based on the performance data and/or any other suitable metric or combination of metrics, and/or based on an indicator sent from process 301 at 318, whether the classifier has been sufficiently trained. Any suitable performance data can be used to determine whether the classifier has been sufficiently trained, in some embodiments. For example, in some embodiments, process 301 can determine that the classifier has been sufficiently trained when the accuracy of the classifier is within one standard deviation or other statistic distance (e.g., 10%) of the known workload types indicated in the training data.

If process 350 determines at 368 that the classifier has been sufficiently trained, process 350 can loop back to 356.

Otherwise, the process can save the trained classifier at 370 and then end at 372. The trained classifier can be saved for later use in the present SSD and/or one or more other SSDs separate from the present SSD.

Turning to FIG. 3B, an example 380 of a process for training a machine learning classifier that can be used to determine a workload type in accordance with some embodiments is illustrated. Process 380 can be executed by any suitable computing device, such as a host, in some embodiments.

As shown, after process 380 begins at 381, the process can enter the training mode at 382. Process can enter the training mode in any suitable manner, in some embodiments. For example, in entering the training mode, process 380 can cause a classifier to be configured to be trained. As another example, in some embodiments, a classifier can be initialized. More particularly, for example, when implemented with a neural network, the classifier can be initialized with normal Xavier initialization and zero biases.

Next, at 383, process 380 can select one or more workload types upon which the classifier is to be trained. Any suitable workload types and suitable number of them can be selected at 383, and the workload types can be selected based on any suitable criteria or criterion. For example, in some embodiments, process 380 can select certain workload types that are applicable to a particular type of SSD, a particular application for an SSD, a particular industry for which an SSD is intended, one or more particular customers, etc.

Then, at 384, process 380 can select a training dataset based on the selected workload type(s). Any suitable training dataset can be selected in any suitable manner, and the training dataset can have any suitable size. For example, in some embodiments, the training dataset can be selected to have workload examples that correspond to the select workload types.

In some embodiments, the training dataset can have any suitable content. For example, in some embodiments, the training dataset can include workload commands and data as well as indicators that indicate, for each portion of the training dataset, the workload type that corresponds to that portion.

Next, at 385, process 380 can execute a portion of the training dataset as one or more workloads for training. This portion can be executed in any suitable manner. For example, this portion can be executed in the same manner as a corresponding non-training workload would be executed in an SSD, in some embodiments. As another example, in some embodiments, process 380 can simulate execution of the training dataset as one or more workloads. As yet another example, in some embodiments, when training a classifier for one or more given SSDs, workload metrics/information corresponding to workload executions on one or more other SSDs can be used to simulate the execution of workloads on the one or more given SSDs. This allows SSD classifiers to be trained based on past data from different SSDs and different host configurations.

Process 380 can generate workload metrics at 386. Any suitable workload metrics can be generated in any suitable manner, in some embodiments. For example, in some embodiments, generated workload metrics can include a moving average validity (MAV) of bands in an SSD processed for garbage collection while processing the workload, a read/write input/out mix of the workload, a queue depth of the workload, input/output sizes of the workload, a read type (e.g., system or host) of the workload, a number of outstanding commands of the workload, start logical block address (LBA), input/output source (e.g., host, system, garbage collection, media policy, etc.), and/or any other suitable metrics.

Next, at 387, process 380 can train the classifier based on the workload metric(s) and known workload type(s) of the executed workload(s). The classifier can be trained using the received workload(s) in any suitable manner, in some embodiments. For example, in some embodiments, process 380 can provide the classifier with workload metrics from a given number of intervals (as described below in connection with 406 of FIG. 4), receive an output from the classifier, and modify the classifier through backpropagation based on the output and the workload type(s) indicated by the training dataset. In some embodiments, the classifier can be trained using an adaptive moment estimation (“Adam”) optimizer.

After training is complete, at 388, process 380 can enter a testing mode. Process 380 can enter the testing mode in any suitable manner, in some embodiments. For example, in entering the testing mode, process 380 can cause a classifier of the SSD to be configured to evaluate workloads presented to determine their workload types as well as monitor the accuracy of those determinations based on indicators of workload type(s) provided with the workloads.

Next, at 389, process 380 can execute another portion of the training dataset as test workload(s). For example, this other portion can be executed in the same manner as a corresponding non-training workload would be executed in an SSD, in some embodiments. As another example, in some embodiments, process 380 can simulate execution of the training dataset as one or more workloads.

Then, at 390, process 380 can generate testing performance data. This performance data can be generated in any suitable manner, and any suitable performance data can be generated, in some embodiments. For example, in generating the performance data, process 380 can evaluate workloads presented to determine their workload types (e.g., as described below in connection with 404, 405, 406, 408, and 412 of FIG. 4) as well as monitor the accuracy of those determinations based on indicators of workload type(s) provided with the workloads, in some embodiments.

At 391, process 380 can then determine, based on the performance data and/or any other suitable metric or combination of metrics, whether the classifier has been sufficiently trained. Any suitable performance data can be used to determine whether the classifier has been sufficiently trained, in some embodiments. For example, in some embodiments, process 301 can determine that the classifier has been sufficiently trained when the accuracy of the classifier is within one standard deviation or other statistic distance (e.g., 10%) of the known workload types indicated in the training data.

If process 380 determines at 391 that the classifier has not been sufficiently trained, the process can loop back to 383.

Otherwise, the process can save the trained classifier at 392 and then end at 393. The trained classifier can be saved for later use in one or more SSDs.

Turning to FIG. 4, an example 400 of a process for using a machine learning classifier to determine workload types in accordance with some embodiments is illustrated. Process 400 can be executed by an SSD controller, in some embodiments. In some embodiments, process 400 can be performed during 202 of process 200 of FIG. 2.

After process 400 begins at 402, the process can determine current workload metrics for a current workload for a current time interval at 404. Process 400 can determine any suitable current workload metrics in any suitable manner, in some embodiments. For example, in some embodiments, process 400 can determine one or more of a moving average validity (MAV) of bands in an SSD processed for garbage collection while processing the workload, a read/write input/out mix of the workload, a queue depth of the workload, input/output sizes of the workload, a read type (e.g., system or host) of the workload, a number of outstanding commands of the workload, start logical block address (LBA), input/output source (e.g., host, system, garbage collection, media policy, etc.), and/or any other suitable inputs. The current time interval can have any suitable duration, in some embodiments. For example, the current time interval can have a duration of a value from 1-25 ms in some embodiments. In some embodiments, as represented by the dashed lines around box 405 and the dashed lines between box 405 and box 404, when process 400 first begins, 404 and 405 (at which process 400 can wait for the next interval) can be repeated over N+1 intervals before proceeding to 406.

Next, at 406, process 400 can provide the workload metrics for the current time interval and N past time intervals as inputs to the classifier. N can have any suitable value, in some embodiments. For example, in some embodiments, N can be two so that workload metrics for three total time intervals are provided to the classifier. These inputs can be provided in any suitable manner, in some embodiments.

Then, at 408, process 400 can receive a steady state indicator, one or more workload type indicators, for each of a plurality of workload type indicators, a likelihood that the current workload is of that workload type, and/or any other suitable output from the classifier. Such output(s) can be received in any suitable manner, in some embodiments.

At 410, process 400 can next determine the workload type based on the steady state indicator, the one or more workload indicators, for each of a plurality of workload type indicators, a likelihood that the current workload is of that workload type, and/or any other suitable outputs of the classifier, and output the determined workload type. This determination can be made in any suitable manner, in some embodiments. For example, in some embodiments, process 400 can determine the workload type by determining which of the indicated output type has the highest likelihood of being the current workload type.

Process 400 can then end at 412.

It should be understood that at least some of the above described blocks of the processes of FIGS. 2-4 can be executed or performed in any order or sequence not limited to the order and sequence shown in and described in the figures. Also, some of the above blocks of the processes of FIGS. 2-4 can be executed or performed substantially simultaneously where appropriate or in parallel to reduce latency and processing times. Additionally or alternatively, some of the above described blocks of the processes of FIGS. 2-4 can be omitted.

In some implementations, any suitable computer readable media can be used for storing instructions for performing the functions and/or processes described herein. For example, in some implementations, computer readable media can be transitory or non-transitory. For example, non-transitory computer readable media can include media such as non-transitory forms of magnetic media (such as hard disks, floppy disks, etc.), non-transitory forms of optical media (such as compact discs, digital video discs, Blu-ray discs, etc.), non-transitory forms of semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for controlling a number of host requests to be processed and a number of relocations to be performed in a solid-state drive (SSD), comprising:
memory; and
at least one hardware processor coupled to the memory and collectively configured to at least:
determine a workload type of the SSD;
determine an available bandwidth of the SSD based on at least the workload type;
determine a number of host requests allowed to be processed during a current time interval based at least on the available bandwidth and a target moving average of flash translation layer (FTL) relocation source bands of the SSD;
determine a number of relocations allowed to be performed in the SSD during the current time interval based at least on a number of host requests that were allowed to have been processed in a previous time interval, the target moving average, and an actual moving average of FTL relocation source bands of the SSD; and
control the SSD to process the number of host requests and perform the number of relocations during the current time interval.

2. The system of claim 1, wherein the available bandwidth is also based on a queue depth of the SSD and the target moving average.

3. The system of claim 2, wherein the available bandwidth is also based on a number of active bandwidth share requests from one or more media policies.

4. The system of claim 1, wherein the number of host requests allowed to be processed is also based on a number of active data integrity bandwidth share requests.

5. The system of claim 1, wherein the number of host requests allowed to be processed is also based on how long a previous interval took divided by how long the previous interval was anticipated to take.

6. The system of claim 1, wherein the number of host requests allowed to be processed is determined based on an amount of free space on the SSD.

7. The system of claim 1, wherein the number of relocations allowed to be performed is determined based on an amount of free space on the SSD.

8. The system of claim 1, wherein the number of host requests allowed to be processed is based on a number of relocation operations performed during the previous time interval.

9. A method for controlling a number of host requests to be processed and a number of relocations to be performed in a solid-state drive (SSD), comprising:
determining a workload type of the SSD using a hardware processor;
determining an available bandwidth of the SSD based on at least the workload type;
determining a number of host requests allowed to be processed during a current time interval based at least on the available bandwidth and a target moving average of flash translation layer (FTL) relocation source bands of the SSD;
determine a number of relocations allowed to be performed in the SSD during the current time interval based at least on a number of host requests that were allowed to have been processed in a previous time interval, the target moving average, and an actual moving average of FTL relocation source bands of the SSD; and
controlling the SSD to process the number of host requests and perform the number of relocations during the current time interval.

10. The method of claim 9, wherein the available bandwidth is also based on a queue depth of the SSD and the target moving average.

11. The method of claim 10, wherein the available bandwidth is also based on a number of active bandwidth share requests from one or more media policies.

12. The method of claim 9, wherein the number of host requests allowed to be processed is also based on a number of active data integrity bandwidth share requests.

13. The method of claim 9, wherein the number of host requests allowed to be processed is also based on how long a previous interval took divided by how long the previous interval was anticipated to take.

14. The method of claim 9, wherein the number of host requests allowed to be processed is determined based on an amount of free space on the SSD.

15. The method of claim 9, wherein the number of relocations allowed to be performed is determined based on an amount of free space on the SSD.

16. The method of claim 9, wherein the number of host requests allowed to be processed is based on a number of relocation operations performed during the previous time interval.

17. A non-transitory computer-readable medium containing computer executable instructions that, when executed by a processor, cause the processor to perform a method for controlling a number of host requests to be processed and a number of relocations to be performed in a solid-state drive (SSD), the method comprising:
determining a workload type of the SSD;
determining an available bandwidth of the SSD based on at least the workload type;
determining a number of host requests allowed to be processed during a current time interval based at least on the available bandwidth and a target moving average of flash translation layer (FTL) relocation source bands of the SSD;
determine a number of relocations allowed to be performed in the SSD during the current time interval based at least on a number of host requests that were allowed to have been processed in a previous time interval, the target moving average, and an actual moving average of FTL relocation source bands of the SSD; and
controlling the SSD to process the number of host requests and perform the number of relocations during the current time interval.

18. The non-transitory computer-readable medium of claim 17, wherein the available bandwidth is also based on a queue depth of the SSD and the target moving average.

19. The non-transitory computer-readable medium of claim 18, wherein the available bandwidth is also based on a number of active bandwidth share requests from one or more media policies.

20. The non-transitory computer-readable medium of claim 17, wherein the number of host requests allowed to be processed is also based on a number of active data integrity bandwidth share requests.

21. The non-transitory computer-readable medium of claim 17, wherein the number of host requests allowed to be processed is also based on how long a previous interval took divided by how long the previous interval was anticipated to take.

22. The non-transitory computer-readable medium of claim 17, wherein the number of host requests allowed to be processed is determined based on an amount of free space on the SSD.

23. The non-transitory computer-readable medium of claim 17, wherein the number of relocations allowed to be performed is determined based on an amount of free space on the SSD.

24. The non-transitory computer-readable medium of claim 17, wherein the number of host requests allowed to be processed is based on a number of relocation operations performed during the previous time interval.
